(19) United States
(12) Patent Application Publication
(10) Pub. No.: US 2005/0059480 A1
(43) Pub. Date: Mar. 17, 2005

(54) System and method for awarding incentive awards to a player of a gaming device

(75) Inventors: Thomas E. Soukup, Las Vegas, NV (US); Jeffrey George, Las Vegas, NV (US); Doug Huber, Louisville, KY (US); Zhiguo Huang, Henderson, NV (US); Michael D. Crittenden, Henderson, NV (US); Steve Sutherland, Henderson, NV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Konami Gaming, Inc., Las Vegas, NV (US)

(21) Appl. No.: 10/938,677

(22) Filed: Sep. 10, 2004

Related U.S. Application Data
(60) Provisional application No. 60/502,179, filed on Sep. 11, 2003.

(51) Int. Cl. G06F 17/00; G06F 19/00

(52) U.S. Cl. 463/25

(57) ABSTRACT

A system and method for awarding predetermined comps awards to a player playing a gaming device. The comp awards are defined by a casino and stored in a player tracking account. In response to the player meeting a predetermined event or criteria, the player is issued the comp award through the gaming device. The player or the casino will select a delivery method for redeeming the award. The player or the casino will forward the award electronically to another station located in the casino where the comp award will be printed from a station as a comp voucher. The comp voucher may be redeemed at a direct point of redemption in the casino. The comp award may be in the form of a drawing ticket. The drawing ticket may be automatically submitted into a raffle or lottery from the gaming device. The player may also select to have the drawing ticket printed from a station and manually submitted into the raffle or lottery.

### CROSS-REFERENCES TO RELATED APPLICATIONS

This application claims priority to U.S. Provisional Application Ser. No. 60/502,179, filed Sep. 11, 2003 which is hereby incorporated by reference.

### FIELD OF THE INVENTION

The present invention relates to a method for awarding incentive awards through a gaming device to players. More specifically, the present invention allows the casino or a player to select and forward a predetermined comp award to a station within the casino from the electronic gaming device.

### BACKGROUND OF THE INVENTION

The use of connecting a plurality of gaming devices over a network to a host computer is known within the art. Also known within the art is the use of a player tracking account maintained within the host computer for tracking a player's play within a casino. The player is issued a player tracking card by the casino which is inserted into a reader located on the gaming device. These readers may be installed on kiosks or host workstations located throughout the casino.

The player tracking account provides casinos with the ability to monitor a player's play and to compensate the players based on any predetermined event or criteria as established by the casino by awarding incentive awards. The incentive awards may include comp awards which may include bonus points, vouchers for specific merchandise and entry into various drawings. The incentive awards may also include awarding players cashable or non-cashable credits which are applied to the gaming device. One such example of issuing gaming credits to a player for redemption at a gaming device is disclosed in U.S. Pat. No. 6,371,852 (the '852 patent) to Acres. The '852 patent discloses the conversion of points accrued by a player's play through the use of a player tracking device which applies the credits to the gaming device for additional wagering. As known within the art, the credits may be cashable, meaning they may be immediately cashed out at the gaming device upon issuance to the player, or they may be in the form of non-cashable credits that are applied to the gaming device for additional wagering.

Standard systems are inflexible and do not provide the casino with the maximum benefits and advantages now available from the information and systems not available.

The present invention is aimed at one or more of the problems as set forth above.

### BRIEF SUMMARY OF THE INVENTION AND ADVANTAGES

The subject invention provides a system for issuing comp awards to a player from a gaming device. The gaming device is electrically coupled to a host computer by a network. A database within the host computer includes a player tracking account. A predetermined comp award is loaded into the player tracking account and awarded to the player in response to the player completing a predetermined event as established by the casino. The player is notified of the award through the gaming device and a delivery option is displayed in the gaming device which allows the player to forward the predetermined award to another station within the casino.

The subject invention provides a method of issuing incentive awards to a player through an electronic gaming device. The method includes the steps of establishing a player tracking account in storage device, reading a player's identification at the gaming device, electrically coupling the gaming device with the player tracking account, notifying the player of the predetermined award at the gaming device and forwarding the comp award electronically to another station.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a block diagram of a system for awarding comp awards to a player through a gaming device;

FIG. 2 is a block diagram of a gaming device for use with the system of FIG. 1;

FIG. 3 is a flow diagram of a system for awarding comp awards to the player through a gaming device;

FIG. 4 is a flow diagram for a system for awarding drawing tickets to the player through a gaming device; and

FIG. 5 is a diagram of a portion of the computer application program for awarding comp awards to a player through a gaming device.

### DETAILED DESCRIPTION OF THE INVENTION

Referring to the Figures, wherein like numerals indicate like parts throughout the several views, the present invention provides a gaming system 10 and a method 30 for awarding incentive awards to a player 24 through a gaming device 12. Specifically, the incentive awards may include any of the following: cashable credits, non-cashable credits and pre-determined comp awards. The comp awards further includes a plurality of bonus points accrued and used by the player 24 in exchange for merchandise, gifts, meals or services. A plurality of vouchers for merchandise may be issued as comp awards from the casino to the player 24. The vouchers for merchandise include gifts, meals or services as generally provided by the casino.

The casino may issue drawing tickets as comp awards for entry into various lotteries or raffles. The lotteries or raffles are generally held for awarding the players with merchandise or services as provided by the casino. The comp awards are not to be understood as being limited to those as stated above, they may include other items of merchandise or services known or adopted within the gaming industry.

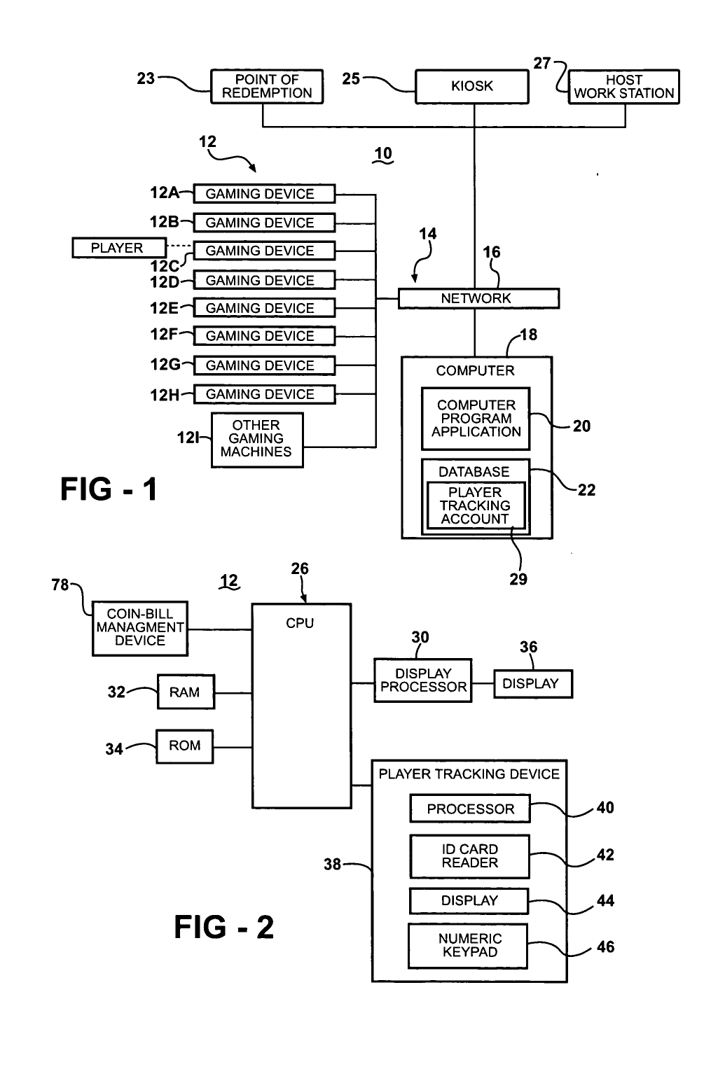

As shown in FIG. 1, the gaming system 10 includes a plurality of gaming devices 12. Gaming devices 12 may include video slot machines, video poker machines, video arcade games, and virtual gaming devices, e.g. for online gaming, an interface to a table management system for table games. It should be noted that the gaming devices 12 should not be limited to those listed above.

In the illustrated embodiment and as shown in FIG. 1, eight electronic gaming devices 12A-12H are shown. The other gaming devices 12I as shown in FIG. 1 represent an infinite amount of gaming devices as placed throughout the casino. The present invention is not limited to a specific number of gaming devices 12. Typically, the gaming devices 12 are organized into banks or groups within the casino. A player 24 is defined as a patron visiting the casino who makes a wager while playing the gaming device 12.

The gaming devices 12 are connected via a network 16 to one or more host computers 18, which are generally located at a remote or central location. The computer 18 includes a computer application program 20 which maintains one or more databases 22. A player tracking account 29 is setup within the database 22 for maintaining a record of incentive awards issued to the player 24.

The player tracking account 29 is limited to including players 24 who have received a player tracking card (not shown) or a player identification number from the casino. The system 10 further includes a plurality of stations 12, 23, 25, 27. The stations 12, 23, 25, 27 include the gaming devices 12A-12I, a point of redemption 23 (e.g. a giftshop or restaurant), a kiosk 25, and a host workstation 27. The stations 12, 23, 25, 27 are connected to the network 14. The point of redemption 23 may include an electronic device (not shown) connected to the network 16. The electronic device may be in the form a computer for receiving information over the network. If the point of redemption 23 does not include the electronic device for establishing a connection to the network, the point of redemption 23 would not be included as a station and would not receive any information from the host computer 18. The host workstation 27 is a standalone computer station located in a pit on the casino floor. The host workstation 27 is generally operated by a casino attendant.

The computer program application 20 and the database 22 may be used to record, track, and report accounting information regarding the operation of the gaming devices 12. As stated above, the player tracking account 29 maintains a record of the comp awards issued to the players 24.

Referring to FIG. 2, the gaming device 12A may include a game controller 26, or central processing unit (CPU), a coin management device 28, a display processor 30, a RAM 32 as a memory device and a ROM 34 (generally provided as an EPROM). The CPU 26 is mainly composed of a microprocessor unit (not shown) and performs various calculations and motion control necessary for the progress of the game. The coin-bill management device 28 detects the insertion of a coin or bill. A display 26 displays desirable images (not shown) in response to the display processor 30 interpreting commands issued from the CPU 26. The RAM 32 temporarily stores programs and data necessary for the progress of the game, and the ROM stores, in advance, programs and data for controlling basic operation of the machine 12A, such as the booting operation thereof, game code and graphics.

A player interface is established via mechanical switches or buttons or via a touch screen interface (not shown). Such gaming devices 12 are well known within the art and are therefore not discussed further.

A player tracking device 38 is used as an interface between the gaming device 12A and the player 24 for providing the player's identity to the player tracking account 29. More specifically, the player 24 is identified to the player tracking account 29 via the player tracking card or the player identification number which is entered through the player tracking device 38 by the player 24 at each gaming device 12. An ID card reader 42 is disposed within the player tracking device 38 and receives the player tracking card. The gaming device 12A further includes a numeric keypad 46 which serves as an additional interface for the player 24 to input the player identification number. The player tracking device 38 may communicate information between the host computer 18 and the corresponding gaming device 12C.

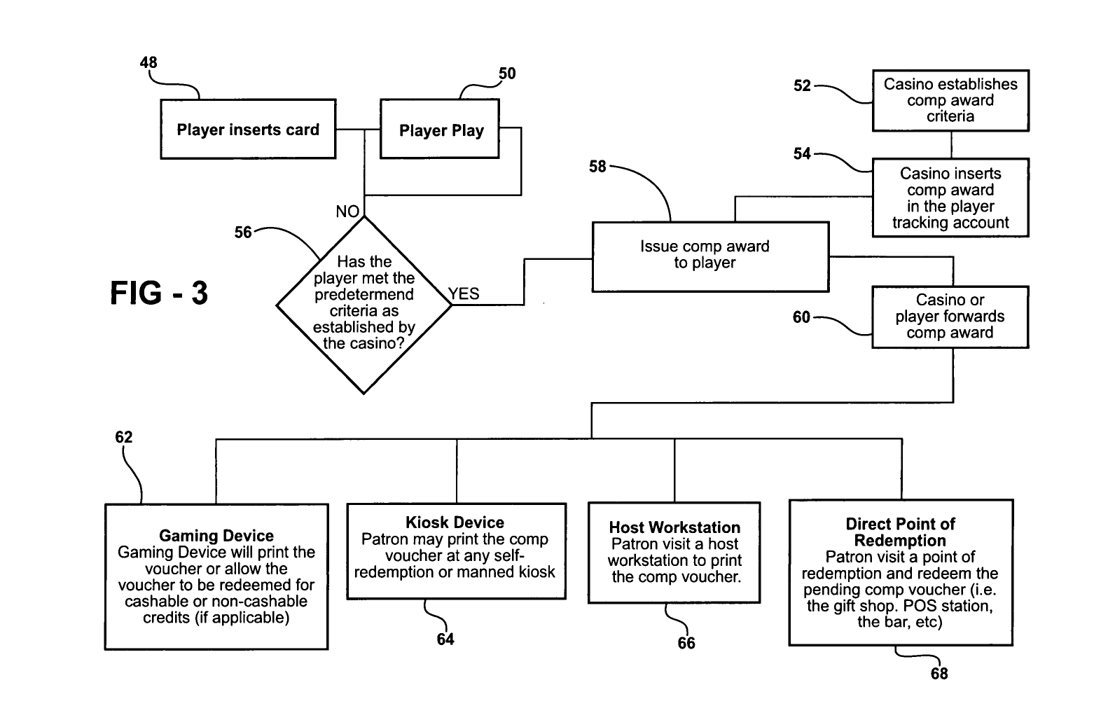

Referring to FIG. 3, a flow diagram showing the steps of awarding the pre-determined incentive awards or comp awards are shown according to one embodiment of the present invention. In step 48, a player 24 inserts the player tracking card into the ID card reader 42 or inputs the personal identification number through the numeric keypad 46. The player 24 is identified to the player tracking account 29 disposed within the database 22. The information related to a player's identity is routed from the gaming device 12C over the network 16 where it is downloaded into the computer 18 and stored in the player tracking account 29. In step 50, the player 24 initiates play with the gaming device 12C and the player tracking account 29 monitors the player's transactions with the gaming device 12C. In step 52, the casino establishes a predetermined event or criteria for issuing the comp award to the player. The predetermined event or criteria may include and is not limited to the number of attempts or plays at the gaming device 12C, the number of attempts or plays at various table plays within the casino, marketing efforts as determined by casino management, or issuing the comp awards to the players to encourage gaming play during off peak hours. The predetermined criteria as stored in the player tracking account 29 is discretionary and developed by the casino management.

In step 54, after establishing the predetermined criteria that triggers awarding the player with the predetermined comp award, casino personnel would upload the comp award and the predetermined criteria into the player tracking account 29. This can be done for any player 24 who has a player account established with any given casino. A casino may provide different levels of comp awards each of which having a different face value to give to players and may upload the comp awards and the predetermined criteria into any number of player tracking accounts. Additionally, the comp awards can be distributed from the player tracking accounts over the network 16 to the gaming devices 12. Generally, the comp awards will be pre-selected from a list of defined standard comp awards as established by the casino within each of the player tracking accounts.

In step 56, as the player 24 announces his/her identity at the gaming device 12C, or initiates a play with the gaming device 12C, the computer application program 20 recognizes that the predetermined criteria as established by the casino has been met by the player 24. In response to the computer application program 20 recognizing that the player 24 has achieved or met the predetermined criteria, the method moves to step 58 and the comp award is issued to the player 24. In step 60, the casino may select the delivery method for the player 24 to print or redeem the comp award at any station 12, 23, 25, 27 on the casino floor. In step 64, the casino may direct the player 24 to walk to any kiosk 25 within the casino, there the player 24 would print a comp award voucher in response to the player 24 either entering the player tracking card or inputting a personal identification number.

In step 68, the casino may direct the player 24 to redeem the comp award at a direct point of redemption which includes a gift shop, bar or a point of sale station located within the casino. As discussed above, the point of redemption must include an electronic device that is coupled to the network 16 for allowing the player 24 to forward and redeem the comp award at the point of redemption 23. If the casino does not include the electronic device for receiving comp awards over the network 16, the comp award voucher may be printed from any one of the gaming devices 12, the kiosk 25 and the host workstation 27. After printing the comp award, the player may return to the point of redemption 23 and collect the comp award.

In step 66, the casino may request that the player 24 visit a host workstation 27 and provide his or her player tracking card to an attendant operating host computer (not shown) in order to print the comp voucher. In step 62, the player may also print the comp award from the gaming devices 12 upon inserting the player tracking card or entering the player identification number.

Additionally, in step 60, the casino may allow for the player 24 to select the mode of delivery. A selection device may be used by the player 24 to forward or send the comp award from the gaming device 12C to another station 12, 23, 25, 27. The selection device includes the display 36 and the numeric keypad 46 on the player tracking device 38, wherein the numeric keypad 46 would serve as a mechanism for the player 24 to forward the comp award to any station 12, 23, 25, 27 within the casino. In step 56, if the player 24 has not met the predetermined criteria as defined by the casino, the player 24 continues to play the gaming device 12 and moves to step 50.

The process as described allows for the player 24 to redeem or print the comp award voucher any time after the comp award was issued to the player 24. Meaning, the player 24 may continue to play the gaming device 12C after the being awarded the comp award. This would allow for the player 24 to continue playing uninterrupted at the gaming device 12C.

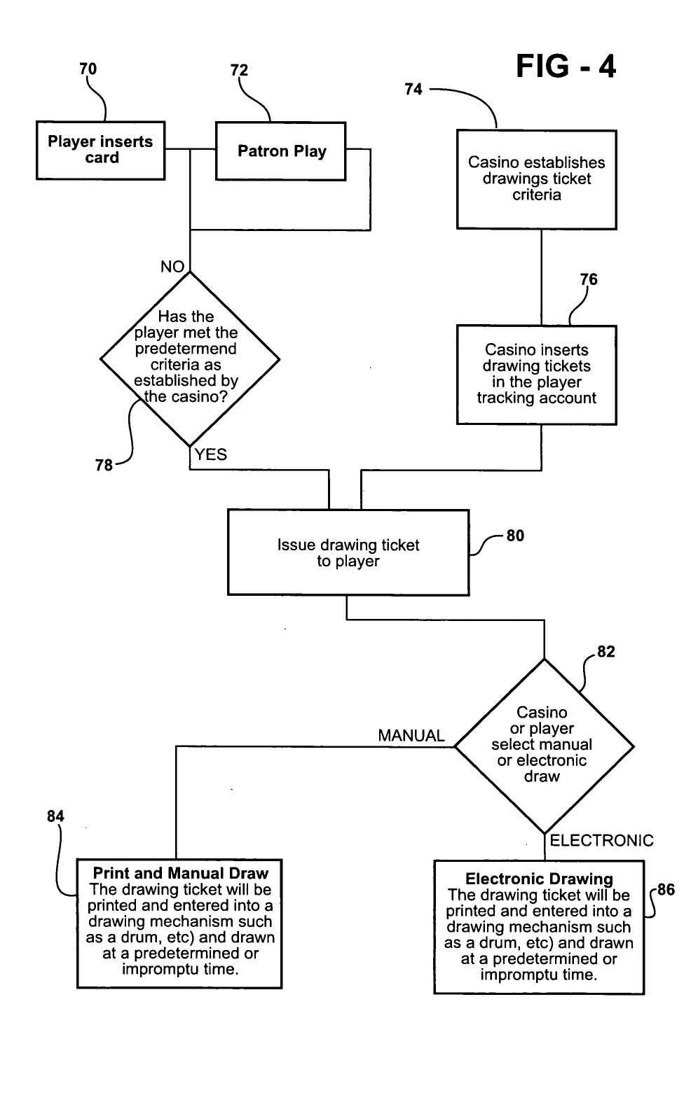

FIG. 4 shows a method for awarding a player at least one drawing ticket. The drawing ticket is a ticket issued by the casino and submitted in a lottery or raffle as determined by the casino. The method is similar to that of awarding comp awards to the players from the gaming device 12. In step 70, the player 24 enters the personal identification number into the numeric keypad 46 or inserts the player tracking card into the ID card reader 42 in the player tracking device 38. In step 72, the player 24 initiates play with the gaming device 12C. In step 74, the casino establishes a predetermined event or criteria for issuing the drawing tickets to the player 24.

In step 76, after establishing the predetermined criteria which triggers awarding the player 24 with the drawing ticket, casino personnel would upload the drawing ticket as the comp award to be issued to the player 24 in the player's player tracking account 29. In step 78, as the player 24 either announces his/her identity or initiates a play with the gaming device 12C, the computer application program 20 recognizes that the predetermined criteria as established by the casino has been met by the player 24. In step 80, the drawing tickets are issued to the player 24 in response to the computer application program 20 recognizing that the player 24 has achieved or met the predetermined criteria. In step 82, upon issuing the drawing tickets to the player 24, the casino or the player 24 may select how to redeem the drawing tickets.

In step 84, a manual drawing ticket may be printed from any station 12, 23, 25, 27. After the player takes possession of the manual drawing tickets from any of the stations 12, 23, 25, 27; the player 24 inserts the manual drawing tickets into a drum whereby the player 24 is entered into the lottery or raffle. In step 86, the player 24 may also select the drawing ticket as an electronic drawing ticket whereby the electronic drawing tickets are automatically entered into the lottery or raffle in response to the player redeeming the electronic tickets from any of the stations 12, 23, 25, 27.

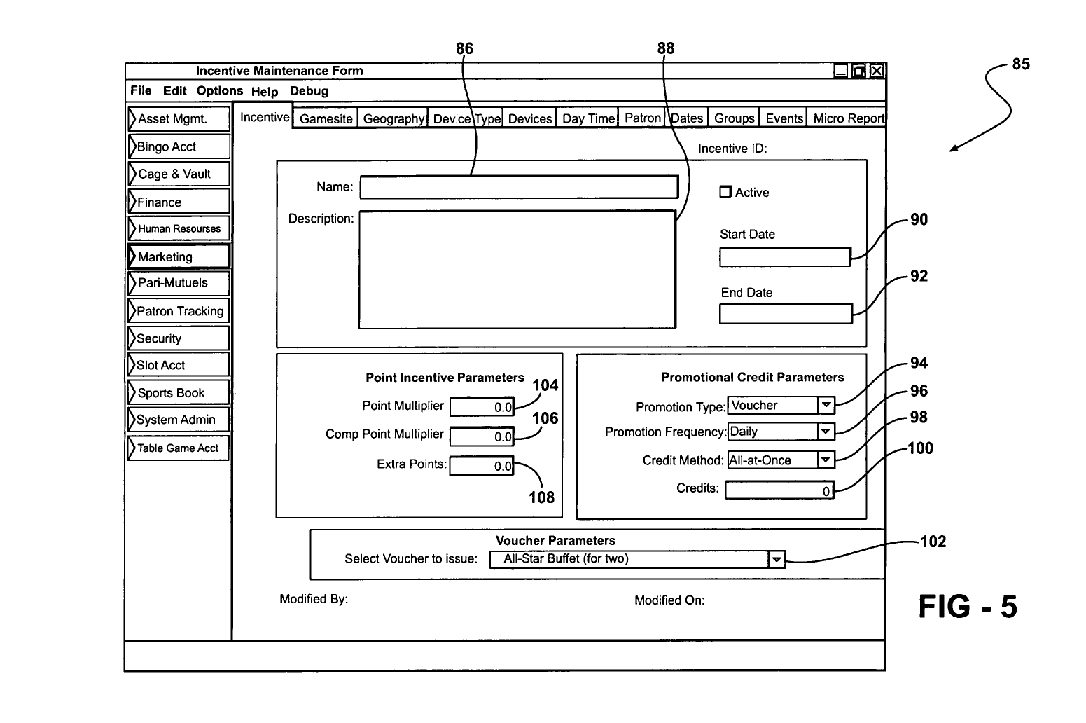

FIG. 5 shows a portion of the computer application program 85 which includes various fields for allowing casino personnel to change, modify or add various types of information related to awarding comp awards to players. The portion of the computer application program 85 includes a field for inserting a players name 86, a description field 88 which may be used to indicate if the player 24 was part of a large group or convention when the player 24 visited the casino. A start 90 and an end date field 92 are provided and these fields may define the period for awarding comp awards.

The portion of the computer application program 85 includes a promotion type field 94, a promotion frequency field 96 which indicates how often the comp award was awarded to any one player 24. The portion of the computer application program 85 also includes a credit method 98 which can award the entire comp award all at once or apply accrued credit received by playing the gaming device 12C or any other table play towards a particular comp award. A credits field 100 is provided which determines the amount of credits needed to award the comp award to the player 24. A voucher parameter field 102 is also provided which determines whether the comp award may be a dinner for two at the casino restaurant or a free limousine ride. The portion of the computer application program 85 includes a point multiplier field 104 and a comp multiplier field. The point multiplier field 104 provides an award of points given to the player 24 based on a predetermined ratio which is then multiplied by a specific value as established by the casino. The comp point multiplier 106 provides an award of points used for issuing the comp awards. The points are normally given and are based on a predetermined ratio which is multiplied by a specified value as established by the casino. An extra point field 108 is provided as this field allows the casino to arbitrarily provide the player with extra points based again on any criteria that the casino may wish to establish.

Obviously, many modifications and variations of the present invention are possible in light of the above teachings. The invention may be practiced otherwise than as specifically described within the scope of the appended claims.

1. A method of issuing incentive awards to a player playing an electronic gaming device, said method comprising the steps of:
establishing a player tracking account in a database;
reading a player identification at a gaming device;
detecting a trigger event;
awarding a predetermined comp award in the player tracking account in response to detecting a trigger event; and
notifying the player of the predetermined comp award at the gaming device.

2. A method as set forth in claim 1 wherein the step of notifying the player of the predetermined comp award in the player tracking account further includes forwarding the comp award electronically to a station.

3. A method as set forth in claim 2 wherein the step of forwarding the award electronically to another station further includes presenting the player with a choice of stations.

4. A method as set forth in claim 3 wherein the step of presenting the player with a choice of stations further includes providing the player with a choice to send the comp award electronically to one of a kiosk, a host workstation, a direct point of redemption, a different gaming device and the gaming device.

5. A method as set forth in claim 4 wherein the step of providing the player with a choice to send the comp award electronically further includes sending the award electronically to one of a kiosk, a host workstation, a direct point of redemption, a different gaming device and the gaming device.

6. A method as set forth in claim 5 wherein the step of sending the award electronically further includes printing a comp award voucher from one of the kiosk, the host workstation, the point of redemption, the different gaming device and the gaming device.

7. A method as set forth in claim 5 wherein the step of printing the comp award voucher further includes taking the comp award voucher to the point of redemption.

8. A method as set forth in claim 6 wherein the step of taking the comp award to the point of redemption further includes redeeming the comp award voucher at the point of redemption.

9. A method as set forth in claim 5 wherein the step of sending the award electronically further includes allowing the player to redeem the comp award as a bonus point for additional play at one of the gaming device and the different gaming device.

10. A method as set forth in claim 1 wherein the step of establishing a player tracking account on the database is further defined as providing a plurality of player tracking accounts for a plurality of players on the database.

11. A method as set forth in claim 10 wherein the step of providing a plurality of player tracking accounts on the database further includes reading any of the players at a plurality of gaming devices.

12. A method as set forth in claim 11 wherein the step of reading any of the players at a plurality of gaming devices further includes awarding a plurality of predetermined comp awards in any of the player tracking accounts.

13. A method as set forth in claim 12 wherein the step of awarding a plurality of predetermined comp awards in any of the player tracking accounts further includes notifying the players of the predetermined incentive awards at the gaming devices.

14. A method as set forth in claim 13 wherein the step of notifying the players of the predetermined comp awards at the gaming devices further includes forwarding the predetermined comp awards electronically to a plurality of stations.

15. A method as set forth in claim 1 wherein the step of awarding a predetermined award in the player account further includes sending the predetermined award from the player tracking account to the gaming device.

16. A method as set forth in claim 1 wherein the step of notifying the player of the predetermined award at the gaming device further includes awarding at least one drawing ticket to the player.

17. A method as set forth in claim 16 wherein the step of awarding at least one drawing ticket to the player further includes entering the drawing tickets electronically into a lottery from the gaming device.

18. A method as set forth in claim 16 wherein the step of awarding at least one drawing ticket to the player further includes printing the drawing tickets from any one of the kiosk, the host workstation, the point of redemption, the different gaming device and the gaming device.

19. A method as set forth in claim 1 wherein the step of awarding a predetermined comp award in the player account further includes sending the predetermined award from the player tracking account to the gaming device.

20. A method as set forth in claim 1 wherein the step of detecting a trigger event further includes establishing a predetermined event in the player tracking account.

21. A gaming system comprising:
a database for establishing a player tracking account;
a gaming device electrically coupled to said player tracking account for reading a player identification;
a predetermined comp award disposed within said player tracking account;
a communication mechanism disposed within said gaming device for notifying the player of said comp award;
a station for electronically receiving the award; and
said system characterized by a selection device for forwarding said award to another station.

22. A gaming system as set forth in claim 21 wherein said stations includes one of a kiosk, a host workstation, a direct point of redemption, a different gaming device and the gaming device.

23. A gaming system as set forth in claim 22 wherein each of said kiosk, said workstation, said direct point of redemption, said different gaming device and said gaming device includes a printer for printing said predetermined award.

24. A gaming system as set forth in claim 23 wherein said predetermined comp award includes a drawing ticket for inserting said drawing tickets into a lottery.

25. A gaming system as set forth in claim 21 further including a host computer.

26. A gaming system as set forth in claim 25 wherein said host computer includes a computer application program for detecting a predetermined event.
